(19) United States
(12) Patent Application Publication
(10) Pub. No.: US 2004/0241081 A1
(43) Pub. Date: Dec. 2, 2004

(54) Innovative grade carbon blacks, methods and apparatuses for manufacture, and uses thereof

(76) Inventors: Jorge Ayala, Kennesaw, GA (US); Jimmy Ivie, Kennesaw, GA (US); Ugo Pedrazzini, Sozzajo (IT); Fabio Guerrini, Trecate (IT); Luciano DiFeliciantonio, S. Giuliano Milanese (IT)

Correspondence Address: NEEDLE & ROSENBERG, P.C., SUITE 1000, 999 PEACHTREE STREET, ATLANTA, GA, 30309-3915, US

(21) Appl. No.: 10/449,520

(22) Filed: May 30, 2003

(51) Int. Cl. C09C 1/48

(52) U.S. Cl. 423/449.1; 524/543; 524/496; 422/150; 422/151; 422/156

(57) ABSTRACT

The present invention is directed to inventive carbon blacks comprising the average nitrogen surface area of a conventional N500 series carbon black and at least one performance property, in a polymeric composition, equal to or better than an identical performance property of a conventional N300 series carbon black in the same polymeric composition. Additionally, the present invention is further directed to various methods and apparatuses for the manufacture of the inventive carbon blacks described herein.

### FIELD OF THE INVENTION

The present invention relates generally to carbon black and improved performance properties thereof.

### BACKGROUND OF THE INVENTION

It is well understood in the rubber industry, such as for use in tires, mechanical rubber goods, moldings and extrusions, hoses, gaskets, belts and the like, that the properties of rubber compounds of a tread type carbon black, such as ASTM N330 grade carbon blacks, are significantly different than those of a carcass-type carbon black, such as ASTM N550 grade carbon blacks. The main differences are in the mechanical performance properties of the compounds, such as moduli, tensile strength, rebound and other properties related the hysteresis of the rubber compound. Typically, N300 series carbon blacks produce compounds with higher modulus, higher tensile strengths, lower rebounds or higher hysteresis than N500 series carbon black containing compounds.

The processing characteristics of N550 and N330 carbon blacks in rubber compounding represent another important difference between these types of carbon blacks. Typically, the N500 series carbon blacks are easier to disperse than N300 series carbon blacks. This is due to the relatively larger particle sizes associated with the N500 series carbon blacks as compared to the N300 series carbon blacks.

It is therefore advantageous in particular applications to have a carbon black that retains or exceeds certain characteristics of the N500 series carbon blacks but is equal to or exceeds the mechanical performance properties of an N300 series carbon black. To that end, it has been discovered by the features of this invention that through geometrical modifications to conventional tread carbon black reactors, it is possible to synthesize a modified or inventive N500 series grade carbon black that provides mechanical performance properties equal to or exceeding those of an N300 series carbon black while maintaining certain characteristics of an N500 series carbon black in desired applications.

### SUMMARY OF THE INVENTION

Among other aspects, the present invention is based upon the surprising discovery of an inventive grade of carbon black that exhibits an average nitrogen surface area of a first ASTM N series carbon black in combination with one or more performance properties of a second different and lower ASTM N series carbon black.

In a first aspect, the present invention comprises a carbon black comprising an average nitrogen surface area of a first conventional N500 series carbon black and an oxygen chemisorption value higher than a second conventional N500 series carbon black.

In a second aspect, the present invention comprises a carbon black comprising an average nitrogen surface area of a conventional N500 series carbon black and at least one performance property, in a polymeric composition, equal to or better than an identical performance property of a conventional N300 series carbon black in the same polymeric composition.

In a third aspect, the present invention comprises a carbon black comprising an average nitrogen surface area of a first conventional N500 series carbon black, at least one performance property, in a polymeric composition, equal to or better than an identical performance property of a conventional N300 series carbon black in the same polymeric composition; and an oxygen chemisorption value higher than a second conventional N500 series carbon black.

In a fourth aspect, the present invention comprises a process for the manufacture of a carbon black, the process comprising the steps of combusting an oxidant and a fuel in a combustor section of a modified tread carbon black reactor to provide at least one combustion gas; injecting a carbonaceous feedstock into a choke section of the carbon black reactor; and reacting the carbonaceous feedstock with the at least one combustion gas in a modified tread reactor having a choke velocity at the carbonaceous feedstock injection less than the choke velocity at the carbonaceous feedstock injection of a conventional tread reactor.

In a fifth aspect, the present invention comprises a process for the manufacture of a carbon black, the process comprising the steps of combusting an oxidant and a fuel in a combustor section of a modified tread carbon black reactor to provide at least one combustion gas; injecting a carbonaceous feedstock into a choke section of the carbon black reactor; and reacting the carbonaceous feedstock with the at least one combustion gas in a modified tread reactor having a choke velocity at the carbonaceous feedstock injection less than the choke velocity at the carbonaceous feedstock injection of a conventional tread reactor, to provide a carbon black comprising an average nitrogen surface area of a first conventional N500 series carbon black.

In a sixth aspect, the invention comprises a product made by the inventive processes described herein.

In a seventh aspect, the present invention comprises a modified tread carbon black reactor for producing carbon black, wherein the reactor comprises, in open communication and in the following order, from upstream to downstream, a combustion section, wherein the combustion section comprises at least one inlet for introducing a combustion feedstock; a choke section, wherein the choke section comprises at least one inlet, separate from the combustion section inlet, for introducing a carbonaceous feedstock and wherein the choke section converges toward a downstream end, said downstream end having a minimum cross sectional area; a quench section, having a minimum cross sectional area, wherein the quench section comprises at least one inlet, separate from the combustion section and choke section inlets, for introducing a quench material; and a breeching section; wherein the ratio of the quench section minimum cross sectional area to the choke section minimum cross sectional area is less than the ratio of a quench section minimum cross sectional area to a choke section minimum cross sectional area of a conventional tread reactor.

In still an eighth aspect, the present invention comprises a polymeric composition comprising a polymer and the inventive grade carbon black as mentioned above.

Additional advantages of the invention will be obvious from the description, or may be learned by practice of the invention. Additional advantages of the invention will also be realized and attained by means of the elements and combinations particularly pointed out in the appended claims. Therefore, it is to be understood that both the foregoing general description and the following detailed description are exemplary and explanatory of certain embodiments of the invention, and are not restrictive of the invention as claimed.

### BRIEF DESCRIPTION OF THE FIGURES

The appended Figure, which is incorporated in and constitutes part of the specification, illustrates a schematic view of one aspect of the modified axial tread carbon black reactor used to manufacture the carbon blacks of the present invention.

### DETAILED DESCRIPTION OF THE INVENTION

The present invention may be understood more readily by reference to the following detailed description and any examples provided herein. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular forms “a,” “an,” and “the” comprise plural referents unless the context clearly dictates otherwise. For example, reference to a component in the singular is intended to comprise a plurality of components.

Ranges may be expressed herein as from “about” or “approximately” one particular value and/or to “about” or “approximately” another particular value. When such a range is expressed, another embodiment comprises from the one particular value and/or to the other particular value. Similarly, when values are expressed as approximations, by use of the antecedent “about,” it will be understood that the particular value forms another embodiment.

As used herein, a weight percent of a component, unless specifically stated to the contrary, is based on the total weight of the formulation or composition in which the component is included.

As used herein, parts per hundred rubber (“PHR”), unless specifically stated otherwise, is based on one hundred weight parts of rubber found within a rubber composition. For example, 5 PHR of component “X” refers to 5 parts by weight of component “X” for every 100 parts by weight of rubber within the composition.

As used herein, by use of the term “effective,” “effective amount,” or “conditions effective to” it is meant that such amount or reaction condition is capable of performing the function of the compound or property for which an effective amount is expressed. As will be pointed out below, the exact amount required will vary from one embodiment to another, depending on recognized variables such as the compounds employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, oxygen chemisorption is a measurement of the surface area of carbon black sample covered by adsorbed oxygen divided by the sample weight. The oxygen surface area is often expressed as an area ratio to nitrogen surface area (O/N₂ ratio). This ratio is a useful indication of the number of active edge-sites present on the surface of a carbon black particle. The procedure for testing and calculating the oxygen chemisorption value is a thermogravimetric technique, wherein a sample of carbon black is dried at 125° C. under nitrogen atmosphere for 5 minutes, followed by heating the sample to 950° C. at a heating rate of 30° C. per minute and then held isothermally for 15 minutes. The sample is then cooled to 300° C. at a cooling rate of 25° C. per minute and held at 300° C. for 15 minutes. Oxygen is then introduced at a flow rate of 400 cc per minute over the sample for 20 minutes. The weight gain of the sample at 300° C. in the presence of oxygen is recorded. The total number of oxygen molecules adsorbed by the sample is calculated using Avogadro's number. The surface area of carbon black sample covered by the adsorbed oxygen is calculated from the total number of oxygen molecules adsorbed and an average oxygen molecular cross-sectional area of approximately 8.3 square angstroms. The chemisorbed oxygen surface area is then divided by the weight of the carbon black sample and expressed as square meters per gram of sample (m²/g).

As used herein, the nitrogen surface area (“NSA”) is measured in units of meters squared per gram sample (m²/g) and is measured according to the ASTM-D6556 testing method.

As used herein, the oxygen to nitrogen area ratio (O/N₂) is a value that represents the oxygen chemisorption value of a carbon black sample divided by the nitrogen surface area of the same carbon black sample.

As used herein, a “typical” or “conventional” carbon black is a carbon black that has been manufactured using a conventional reactor such as a conventional carcass or a conventional axial tread reactor. For example, conventional N300 series carbon blacks can be any grade within the N300 series and can include, but are not limited to, the Statex N326, N330, N339, N343, N347, N351 and N375 available from Columbian Chemicals Company, Marietta, Georgia, USA. Likewise, conventional N500 series carbon blacks can be any grade within the N500 series and can include, but are not limited to, the Statex N550 and N539, also available from Columbian Chemicals Company, Marietta, Georgia, USA. The same also applies to other series, such as, N400, N600 and N700.

As used herein, a “typical” or “conventional” tread type reactor has separate combustion and reaction sections and produces products at flow velocities of about 300 to about 550 meters per second (m/s), temperatures of about 1500° C. to about 2100° C., and residence times of about 4 to about 200 milliseconds (ms). More specifically, a conventional tread reactor comprises, in open communication and in the following order from upstream to downstream a combustion section, wherein the combustion section comprises at least one inlet for introducing a combustion feedstock; a choke section, wherein the choke section comprises at least one inlet, separate from the combustion section inlet, for introducing a carbonaceous feedstock and wherein the choke section converges toward a downstream end, said downstream end having a minimum cross sectional area; a quench section, having a minimum cross sectional area, wherein the quench section comprises at least one inlet, separate from the combustion section and choke section inlets, for introducing a quench material; and a breeching section. Additionally, in a conventional tread reactor, the ratio of the quench section minimum cross sectional area to the choke section minimum cross sectional area is greater than or equal to 1.5.

As used herein, a “typical” or “conventional” carcass type reactor product is produced at flow velocities of about 2 to about 20 m/s, temperatures of about 600° C. to about 1500° C., and residence times of about 0.5 to about 2 seconds. Combustion of a fuel in addition to feedstock is not always required to provide energy for converting the feedstock in a “typical” carcass type reactor, i.e., in some cases the fuel can be the feedstock without need for another carbonaceous material. A separate combustion zone is not required; combustion of the fuel can occur within the primary reactor.

As set forth above, in one aspect, the present invention provides a carbon black having an ASTM N500 series classification (i.e., a nitrogen surface area) as defined by ASTM D1765. In one sub-aspect of this, the carbon blacks of the invention unexpectedly comprise at least one performance property in a polymeric composition equal to or better than an identical performance property of a conventional ASTM N300 series carbon black in the same polymeric composition. Alternatively, in another sub-aspect, the carbon blacks of the present invention unexpectedly comprise an oxygen chemisorption value higher than the oxygen chemisorption value of a conventional ASTM N500 series carbon black. Furthermore, in still another sub-aspect, the ASTM N500 series carbon blacks of the present invention can also comprise the combination of at least one performance property in a polymeric composition equal to or better than an identical performance property of a conventional N300 series carbon black in the same polymeric composition and an oxygen chemisorption value higher than the oxygen chemisorption value of a conventional ASTM N500 series carbon black.

As used throughout this disclosure, an ASTM N series classification refers to the classification of carbon blacks as defined by the ASTM D1765 standard classification system for rubber grade carbon blacks. ASTM D1765 categorizes rubber grade carbon blacks according to their average nitrogen surface area as measured by ASTM test method D 6556. More specifically, ASTM D 1765 defines the following N group number carbon blacks based on their nitrogen surface area as follows:

TABLE 1
ASTM D1765

| | Average Nitrogen |
|---|---|
| Group No. | Surface Area, m²/g |
| 0 | >150 |
| 1 | 121-150 |
| 2 | 100-120 |
| 3 | 70-99 |
| 4 | 50-69 |
| 5 | 40-49 |
| 6 | 33-39 |
| 7 | 21-32 |
| 8 | 11-20 |
| 9 | 0-10 |

Therefore, for purposes of the present disclosure, an N300 series carbon black, whether referred to as a conventional carbon black or otherwise, refers to a carbon black having a nitrogen surface area within the range of from approximately 70 to 99 m²/g as measured by ASTM test method D6556. Such N300 series carbon blacks include, without limitation, such grades as N326, N330, N339, N343, N347, N351 and N375. Likewise, reference to an N500 series carbon black, whether referring to a conventional or an inventive carbon black of the present invention, refers to a carbon black having a nitrogen surface area in the range of from approximately 40 to 49 m²/g as measured by ASTM test method D6556, including such values as 41, 42, 43, 44, 45, 46, 47 and 48 m²/g. Accordingly, the N500 series carbon blacks recited herein can include, without limitation, such grades as N539 and N550. Referring back to Table 1, N600 series carbon blacks can include, without limitation, such grades as N630, N650 and N660. Likewise, N700 series carbon blacks can include, without limitation, such grades as N754, N762, and N774.

The carbon blacks of the present invention advantageously provide several improved performance properties in polymeric compositions when compared to their conventional carbon black counterparts. While these performance properties can be measured in a variety of polymeric compositions, the carbon blacks are particularly well suited for rubber compositions and more specifically for rubber compositions used in the manufacture of tires. The performance properties of both natural and synthetic rubbers are improved when the carbon blacks according to this invention are incorporated therein.

Among the improved performance properties provided by the inventive carbon blacks are improvements in Hysteresis and/or the Stress-Strain properties of polymeric compositions comprising the carbon blacks of the present invention.

Hysteresis is a term used for heat energy expended in a material, such as a cured rubber composition, by applied work. A high hysteresis of a rubber composition is generally indicated by a relatively low rebound, a relatively high internal friction and relatively high loss modulus property value. Therefore, the measured hysteresis of a polymeric composition is a measure of its tendency to generate internal heat under service conditions. A polymeric composition with a higher hysteresis property usually generates more internal heat under service conditions than an otherwise comparable polymeric composition with a substantially lower hysteresis. Thus, in one aspect, polymeric compositions comprising the carbon blacks of the present exhibit a relatively higher hysteresis compared to polymeric compositions comprising the corresponding conventional carbon blacks. This increase in hysteresis is indicative of a carbon black having physical properties of a relatively finer grade conventional carbon black.

The increased hysteresis that results from use of the carbon blacks of the present invention is reflected in their relatively lower rebound properties. As used herein, the term “rebound property” refers the Zwick Rebound measured according to the Zwick Rebound Test-DIN 53512. Accordingly, when measured using the Zwick Rebound Test-DIN 53512 it has been discovered that polymeric compositions containing the carbon blacks of the present invention exhibit rebound measurements that are up to approximately 5% lower than the rebound measurement of the corresponding polymeric compositions containing the corresponding conventional carbon black. This demonstrated decrease in the rebound nieasurements can include such relative decreases as 1,% 2%, 3%, and 4%.

The carbon blacks of the present invention also provide improved stress-strain properties compared to their conventional counterparts. Specifically, when used in polymeric compositions, the carbon blacks of the present invention exhibit a higher modulus and tensile strength measurement, which is also consistent with a carbon black having physical properties of a relatively finer grade conventional carbon black. For example, in comparison to a standard or conventional N550, a standard N330 carbon black will typically exhibit a 1.4 MPa higher 300% modulus and a 4.7 MPa higher tensile strength in a standard SBR (ASTM-D3191) test formulation.

The modulus of a polymeric composition is the tensile stress necessary to elongate a certain specimen to an increased percentage of its original length. Typical modulus measurements are conducted at 100%, 200% and 300% of a specimen's original length. Using the ASTM-D3182 test method, polymeric compositions containing the carbon blacks of the present invention exhibit up to a 16% increase in modulus relative to the modulus of the same polymeric composition containing a corresponding conventional carbon black. This increase in modulus includes such relative increases as 1%, 2%, 3%, 4%, 5%, 6%, 7%, 8%, 9%, 10%, 11%, 12%, 13%, 14%, and 15%.

Similar to modulus as discussed above, polymeric compositions comprising the carbon blacks of the present invention also provide increased tensile strength when compared to the same polymeric composition comprising the corresponding conventional conventional carbon black. When tested according to ASTM-D412 testing procedures, polymeric compositions comprising the carbon blacks of the present invention exhibit tensile strengths that are up to and including 12% higher than the tensile strength of the same polymeric composition comprising a corresponding conventional carbon black. This increase in tensile strength includes such relative increases as 1%, 2%, 3%, 4%, 5%, 6%, 7%, 8%, 9%, 10%, and 11%.

As briefly mentioned above, the carbon blacks of the present invention further comprise oxygen chemisorption values that are significantly increased relative to oxygen chemisorption values of the conventional N500 series carbon black counterparts. In one aspect, the carbon blacks of the present invention exhibit chemisorption values greater than or equal to 2.2 m² absorbed oxygen/gram of carbon black, including without limitation such higher values as 2.3 and 2.5 m² absorbed oxygen/gram. In a more preferred aspect, the carbon blacks of the present invention exhibit an oxygen chemisorption value of at least 3.5 m² absorbed oxygen/gram of carbon black, including without limitation such higher values as 3.5, 3.6 and 3.7 m² absorbed oxygen/gram. In still a more preferred aspect, the carbon blacks of the present invention exhibit an oxygen chemisorption of at least 4.0 ml absorbed oxygen gram of carbon black, including without limitation such values as at least 5.0, 6.0 and 7.0 m² absorbed oxygen/gram. In one aspect, the oxygen chemisorption can be up to and including 8, 9, 10 m² absorbed oxygen/gram or even higher. In another aspect, the oxygen chemisorption can be in the range of from 3.5 to 10 m² absorbed oxygen gram. Alternatively, in another aspect, the oxygen chemisorption can be in the range of from 6 to 9 m² absorbed oxygen/gram.

According to the invention, the oxygen chemisorption value of the carbon black, when viewed relative to the nitrogen surface area of the carbon black provides a calculation-of the oxygen to nitrogen area ratio of the carbon black. In accordance with the chemisorption values set forth above and the nitrogen surface areas previously described, the carbon blacks of the present invention preferably comprise a ratio of oxygen chemisorption to nitrogen surface area of at least 0.07:1. In still another aspect, the ratio of oxygen chemisorption to average nitrogen surface area is at least 0.10:1. In still another aspect, the ratio of oxygen chemisorption to nitrogen surface area is at least approximately 0.15:1.

In another aspect, the present invention provides polymeric compositions comprising the carbon blacks as set forth above and a polymer.

The specific polymer is not critical as the carbon blacks of the present invention can be used in combination with any polymer known to one of ordinary skill in the art for use with carbon blacks as a pigment and/or filler material. The carbon blacks of the present invention are particularly well suited for use in polymeric rubber compositions used in the manufacture of tires.

The suitable weight ratios of polymer to carbon black within the polymeric compositions will be dependent on the desired application and will be known to one of ordinary skill in the art or readily determined through routine experimentation.

The polymeric compositions can be made by any method previously known in the art. For example, the carbon black can be added to the polymer and mixed with a conventional mixer, such as a banbury mixer. These compositions can also comprise additional additives as desired and/or needed according to the particular application.

In still another aspect, the present invention provides a process for the manufacture of a carbon black having the properties or combination of properties as previously described herein. In one aspect the process comprises the steps of combusting an oxidant and a fuel in a combustor section of a modified tread carbon black reactor to provide at least one combustion gas; injecting a carbonaceous feedstock into a choke section of the carbon black reactor; and reacting the carbonaceous feedstock with the at least one combustion gas in a modified tread reactor having a choke velocity at the carbonaceous feedstock injection less than the choke velocity at the carbonaceous feedstock injection of a conventional tread reactor.

In alternative aspects of the present invention, the choke velocity at the carbonaceous feedstock injection is at least 10%, 20%, 30%, 40%, 50%, 60%, 70%, 80% or even 90% less than the choke velocity at the carbonaceous feedstock injection of a conventional tread reactor. In a preferred aspect, the choke velocity at the carbonaceous feedstock injection is at least 50% less than the choke velocity at the carbonaceous feedstock injection of a conventional tread reactor. As described herein, the flow velocity of a conventional tread reactor is in the range of from about 300 to 550 meters per second. Therefore, according to various aspects of the present invention, the choke velocity at the carbonaceous feedstock injection is less than 300 m/s, or less than or equal to 250 m/s, 200 m/s, 180 m/s, 150 m/s or even less than or equal to 100 m/s. Moreover, in accordance with additional sub-aspects of this embodiment, the choke velocity is a minimum rate of at least 25 m/s, 50 m/s or even 75 m/s.

The scope of the present invention is not limited to inventive grade carbon blacks comprising one or more properties of an ASTM classified N500 series grade carbon black and one or more properties of an ASTM classified N300 series grade carbon black. Rather, in further aspects of the present invention are inventive carbon blacks comprising an average nitrogen surface area of a first conventional ASTM classified N400, N500, N600 or N700 series grade carbon black and at least one performance property, in a polymeric composition, equal to or better than an identical performance property of a second and different conventional ASTM classified N300, N400, N500, or N600 series carbon black. This second conventional N series carbon black is a lower numbered series carbon black from the first conventional N series carbon black. For example, in an aspect where the first N series carbon black is an N700 series, the second N series carbon black is an N300 to N600 series carbon black. Accordingly, in view of the present disclosure, one of ordinary skill in the art will appreciate that the optimum process conditions required to obtain these additional inventive carbon blacks can be obtained through no more than routine experimentation.

In still another aspect, the present invention comprises a modified tread carbon black reactor for producing a carbon black of this invention.

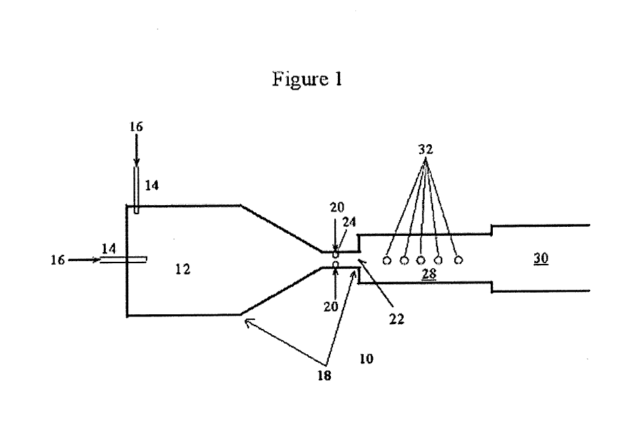

With specific reference to the appended FIG. 1, a modified tread carbon black reactor 10 for producing a carbon black of this invention is disclosed. The reactor 10 for producing carbon black comprises, in open communication and in the following order from upstream to downstream a combustion section 12, wherein the combustion section comprises at least one inlet 14 for introducing a combustion feedstock 16; a choke section 18, wherein the choke section comprises at least one inlet 24, separate from the combustion section inlet, for introducing a carbonaceous feedstock 20 and wherein the choke section converges toward a downstream end 22, said downstream end having a minimum cross sectional area; a quench section 28, having a minimum cross sectional area, wherein the quench section comprises at least one inlet 32, separate from the combustion section and choke section inlets, for introducing a quench material; and a breeching section 30; wherein the ratio of the quench section minimum cross sectional area to the choke section minimum cross sectional area is less than the ratio of a quench section minimum cross sectional area to a choke section minimum cross sectional area of a conventional tread reactor.

In a preferred aspect, the modified tread carbon black reactor of the present invention comprises a ratio of the minimum cross sectional area of the quench section to the minimum cross sectional area of the choke section that is in the range of from greater than 1.0 to less than 1.5, including without limitation such ranges as from a lower end of greater than from 1.0, 1.05, 1.1, 1.15, 1.2, 1.25 or 1.3 to an upper limit of approximately 1.1, 1.2, 1.3, or 1.4.

Aside from a change in the ratio of cross-sectional area of the quench section to the cross-sectional area of the choke section, the reactor has the same physical apparatus features of a conventional tread reactor. The reactor comprises conventional materials of construction, conventional geometry of the sections and inlets, uses conventional fuel and oxidant, uses conventional quench materials, and the other conventional characteristics as would be apparent to one of ordinary skill in the art. Of course, some process conditions within the inventive modified tread reactor are different from a conventional tread reactor, such as velocities, residence times, reaction temperatures and the like, due to the difference in the quench to choke ratio.

The four sections described above need not be physically separate or distinct components, but may be different functional areas within a single formed component. Moreover, it should be understood that the reactor 10 can comprise additional sections, but the above sections would remain in their same order relative to each other from upstream to downstream.

### EXAMPLES

The following examples are put forth so as to provide those of ordinary skill in the art with a complete disclosure and description of how the inventive carbon black, methods and apparatuses for the manufacture thereof, and uses thereof described and claimed herein are made and evaluated. The examples are intended to be purely exemplary and are not intended to limit the scope of what the inventors regard as their invention. Efforts have been made to ensure accuracy with respect to numbers (e.g., amounts, temperature, etc.) but some errors and deviations should be accounted for. There are numerous variations and combinations of reaction conditions that can be used to optimize the product purity and yield obtained from the described process. Accordingly, only reasonable and routine experimentation will be required to optimize such process conditions.

### Example

### Preparation of Inventive Grade Carbon Black

A carbon black according to the present invention was manufactured in a modified axial tread carbon black reactor as previously described herein and as illustrated by FIG. 1. Specifically, the modified axial tread carbon black reactor had a ratio of quench cross sectional area to the cross sectional area of the choke downstream end of 1.3.

In a first step, preheated combustion air and natural gas fuel were mixed to produce a high temperature of approximately 1900 degrees C. within the reactor's combustion zone. A liquid hydrocarbon feedstock, commonly known as conversion oil, was then injected into the reaction zone of the reactor where it at least partially burned and partially cracked (dehydrogenated) to form the carbon black product. The cracking or dehydrogenation reaction took place at a calculated velocity at the point of conversion oil injection of approximately 180 m/s. Upon completion of the cracking reaction, the process gas stream was quenched and cooled by direct injection of water. After the process gases were cooled by direct injection of water to a temperature of approximately 925 degrees C. or cooler, the process gases were then passed through an air/gas heat exchanger. Once having passed through the exchanger, the process gases were further cooled to a temperature in the range of from 260 degrees C. to 290 degrees C. by an additional series of water sprays.

Downstream from the heat exchanger, the process gases were then passed through a series of bag collectors containing several modules consisting of fiberglass cloth bags suspended along the length of the module. The carbon black product present within the process gases collected on the outside of the fiberglass cloth bags. Once collected, the carbon black was dislodged from the fiberglass cloth bags by a pulse of high pressure air and allowed to drop into a hopper section of modules.

The carbon black was then discharged from the bag collector hoppers through a rotary airlock valve and was conveyed to the dense tank bag collector. From the dense tank bag collector, the carbon black was passed through a micropulverizer and into a dense tank which acts as a surge tank for the wet beading process. Once the carbon black was collected in the dense tank, the carbon black was combined with a mixture of approximately 99.8 to 99.9% by weight water and a 0.1 to 0.2% by weight lignin sulfonate beading additive in a horizontal bead machine containing a rotating shaft having several stainless steel pins mounted along the shaft. The addition of the water to the carbon black, combined with the agitation from the stainless steel pins created carbon black beads or pellets. The carbon black was then passed through a second bead machine. Thereafter, the carbon black pellets (or wet beads) were dried at a temperature of approximately 250 to 300 degrees C. to reduce the water content of the beads from about 50% to less than 1%. After drying, the final carbon black product was then directed to storage.

### Example II(a)

### Preparation of SBR Sidewall Rubber Formulation with Conventional Carbon Black

In accordance with the formulation set forth in Table 2 below, a control sample of an SBR Sidewall Rubber composition was prepared using a conventional N550 ASTM grade carbon black. The ingredient weights were calculated to fill a banbury mixing chamber to 70% in first pass of a two pass mix. Rotor speed was 77 rpm. The elastomer was added at the starting time. The first half of the carbon black, zinc oxide, stearic acid, flexzone 7P, shellwax 400, and Octamine were added at 30 seconds. The other half of carbon black and oil were added at 1.5 minutes. The ram was raised and swept 2.5 minutes. Mixing continued until a drop at 4.5 minutes. The compound was then put into the banbury for a second pass. Rotor speed was 77 rpm. At starting time half of first pass was added, then MBS and sulfur, then remaining half of first pass. Mixing continued until a drop at 2.5 minutes. The prepared sample was then tested for modulus, tensile strength and resilience. The results of these tests are illustrated as Sample B on Table 7.

TABLE 2

| Ingredient | Chemical Name | Source | PHR |
|---|---|---|---|
| SBR 1500 | Styrene Butadiene | Ameripol Synpol | 58 |
| | Rubber | | |
| SBR 1712 | Styrene Butadiene | Ameripol Synpol | 58 |
| | Rubber | | |
| Carbon Black | N550 ASTM Grade | Columbian Chemicals | 75 |
| | Carbon Black | | |
| Sundex 790 | Processing Oil | Sunoco | 14 |
| Stearic Acid | Stearic Acid | Witco Corp | 1.7 |
| Zinc Oxide | Zinc Oxide | USA Zinc Corp | 3.5 |
| Flexzone 7P | N-(1,3 dimethylbutyl)- | Flexsys | 4.0 |
| | N′-phenyl-p- | | |
| | phenylenediamine | | |
| Shellwax 400 | Petroleum Wax | Shell Oil Products | 2.3 |
| Octamine | Octylated Diphenylamine | Uniroyal Chemical | 2.3 |
| MBS | 2-morpholinothio | Flexsys | 1.3 |
| | benzothiazole | | |
| Sulfur | Sulfur | Reagent Chemical | 2.4 |

### Example II(b)

### Preparation of SBR Sidewall Rubber Formulation with Inventive Grade Carbon Black.

In accordance with the formulation set forth in Table 3 below, four identical SBR Sidewall Rubber compositions were prepared using the N550 grade carbon black prepared in Example I above. The ingredient weights were calculated to fill a banbury mixing chamber to 70% in first pass of a two pass mix. Rotor speed was 77 rpm. The elastomer was added at the starting time. The first half of the carbon black, zinc oxide, stearic acid, flexzone 7P, shellwax 400, and Octamine were added at 30 seconds. The other half of carbon black and oil were added at 1.5 minutes. The ram was raised and swept 2.5 minutes. Mixing continued until a drop at 4.5 minutes. The compound was then put into the banbury for a second pass. Rotor speed was 77 rpm. At starting time half of first pass was added, then MBS and sulfur, then remaining half of first pass. Mixing continued until a drop at 2.5 minutes. The four prepared samples were then tested for modulus, tensile strength and resilience. The results of these tests are illustrated as Samples A, C, D and E on Table 7.

TABLE 3

| Ingredient | Chemical Name | Source | PHR |
|---|---|---|---|
| SBR 1500 | Styrene Butadiene | Ameripol Synpol | 58 |
| | Rubber | | |
| SBR 1712 | Styrene Butadiene | Ameripol Synpol | 58 |
| | Rubber | | |
| Carbon Black | N550 Carbon Black of | Columbian Chemicals | 75 |
| | Example I | | |
| Sundex 790 | Processing Oil | Sunoco | 14 |
| Stearic Acid | Stearic Acid | Witco Corp | 1.7 |
| Zinc Oxide | Zinc Oxide | USA Zinc Corp | 3.5 |
| Flexzone 7P | N-(1,3 dimethylbutyl)- | Flexsys | 4.0 |
| | N′-phenyl-p- | | |
| | phenylenediamine | | |
| Shellwax 400 | Petroleum Wax | Shell Oil Products | 2.3 |
| Octamine | Octylated Diphenylamine | Uniroyal Chemical | 2.3 |
| MBS | 2-morpholinothio | Flexsys | 1.3 |
| | benzothiazole | | |
| Sulfur | Sulfur | Reagent Chemical | 2.4 |

### Example III(a):

### Preparation of EPDM Extrusion Rubber Formulation with Conventional Carbon Black.

In accordance with the formulation set forth in Table 4 below, a control sample of an EPDM Extrusion Rubber Formulation was prepared using a conventional N550 ASTM grade carbon black. The ingredient weights were calculated to fill a banbury mixing chamber to 70% in first pass of a two pass mix. Rotor speed was 77 rpm. At the start time, the carbon black, zinc oxide, stearic acid, Sunpar 2280, and elastomer were added to the mixer. The ram was raised and swept at 2 minutes. Mixing continued until a drop at 280 F. The compound was then put onto a two roll mill at 180 F where MBTS, TMTD, ZDEC, and sulfur were added. The sample was cross blended from each side 8 times and then rolled and placed back 15 into the mill end-wise 8 times. The prepared sample was then tested for modulus, tensile strength and resilience. The results of these tests are illustrated as Sample B on Table 8.

TABLE 4

| Ingredient | Chemical Name | Source | PHR |
|---|---|---|---|
| Vistalon 7500 | Ethylene Propylene | Exxon | 100 |
| | Diene Termonomer | | |
| | Rubber | | |
| Carbon Black | Conventional N550 | Columbian | 140 |
| | Carbon Black | Chemicals | |
| Zinc Oxide | Zinc Oxide | USA Zinc Corp | 4.0 |
| Stearic Acid | Stearic Acid | Witco Corp | 1.5 |
| Sunpar 2280 | Processing Oil | Sunoco | 100 |
| MBTS | Benzothiazyl disulfide | | 1.3 |
| TMTD | Tertamethylthiuram | Flexsys | 0.8 |
| | disulfide | | |
| ZDEC | Zinc | Flexsys | 0.8 |
| | Diethyldithiocarbamate | | |
| Sulfur | Sulfur | Reagent | 1.8 |
| | | Chemical | |

### Example III(b):

### Preparation of EPDM Extrusion Rubber Formulation with Inventive Grade Carbon Black.

In accordance with the formulation set forth in Table 5 below, four identical EPDM Extrusion Rubber compositions were prepared using the N550 grade carbon black prepared in Example I above. The ingredient weights were calculated to fill a banbury mixing chamber to 70% in first pass of a two pass mix. Rotor speed was 77 rpm. At start time the carbon black, zinc oxide, stearic acid, Sunpar 2280, and elastomer were added to the mixer. The ram was raised and swept at 2 minutes. Mixing continued until a drop at 280 F. The compound was then put onto a two roll mill at 180 F where MBTS, TMTD, ZDEC, and sulfur were added. The sample was then cross blended from each side 8 times and then rolled and placed back into mill end-wise 8 times. The four prepared samples were then tested for modulus, tensile strength and resilience. The results of these tests are illustrated as Samples A, C, D and E on Table 8.

TABLE 5

| Ingredient | Chemical Name | Source | PHR |
|---|---|---|---|
| Vistalon 7500 | Ethylene Propylene | Exxon | 100 |
| | Diene Termonomer | | |
| | Rubber | | |
| Carbon Black | Inventive Grade | Columbian Chemicals | 140 |
| | N550 of Example I | | |
| Zinc Oxide | Zinc Oxide | USA Zinc Corp | 4.0 |
| Stearic Acid | Stearic Acid | Witco Corp | 1.5 |
| Sunpar 2280 | Processing Oil | Sunoco | 100 |
| MBTS | Benzothiazyl disulfide | | 1.3 |
| TMTD | Tertamethylthiuram | Flexsys | 0.8 |
| | disulfide | | |
| ZDEC | Zinc Di- | Flexsys | 0.8 |
| | ethyldithiocarbamate | | |
| Sulfur | Sulfur | Reagent | 1.8 |
| | | Chemical | |

### Example IV

### Comparative Oxygen Chemisorption Measurement

Following the procedure for Oxygen Chemisorption measurement described herein, the oxygen chemisorptions for three conventional N550 grade carbon blacks were compared to the oxygen chemisorption of the inventive grade N550 carbon black prepared in Example 1 above. The results of these measurements are set forth in Table 6 below. Sample's A and B each represent Statex N550 carbon black, obtained from Columbian Chemicals Company, Marietta, Georgia USA. Sample C represents a conventional N550 grade carbon black obtained from the Cabot Corporation, Boston, Mass., USA. Sample D represents the inventive N550 grade carbon black manufacture in Example I above.

TABLE 6

| | Oxygen | NSA | Area Ratio |
|---|---|---|---|
| Sample | m²/g | m²/g | O/N₂ |
| A | 2.19 | 42 | 0.052 |
| B | 2.88 | 40 | 0.069 |
| C | 3.17 | 42 | 0.075 |
| D | 7.86 | 40 | 0.197 |

TABLE 7
N550 - SBR Sidewall Formulation

| | A | B | C | D | E |
|---|---|---|---|---|---|
| Rheometer Cure | | | | | |
| Properties | | | | | |
| ½° | | | | | |
| Arc 165° C. | | | | | |
| (ASTM D 5289) | | | | | |
| Max. Torque, dNm | 15.3 | 15.5 | 15.2 | 15.3 | 15.1 |
| Min. Torque, dNm | 1.5 | 1.4 | 1.4 | 1.5 | 1.5 |
| Net Torque, dNm | 13.8 | 14.1 | 13.8 | 13.8 | 13.6 |
| 1.0 Nm Rise, min. | 4.3 | 4.6 | 4.3 | 4.3 | 4.3 |
| 90% Net, min. | 11.6 | 12.1 | 11.7 | 11.7 | 11.6 |
| Stress Strain | | | | | |
| Properties | | | | | |
| (Cured 32 Minutes | | | | | |
| @ 145° C.)- | | | | | |
| ASTM D412/D3182 | | | | | |
| 100% Mod., MPa | 3.4 | 3.5 | 3.6 | 3.6 | 3.5 |
| 200% Mod., MPa | 8.5 | 8.2 | 8.7 | 8.8 | 8.6 |
| 300% Mod., MPa | 12.8 | 12.0 | 12.8 | 13.0 | 12.7 |
| Tensile, MPa | 15.9 | 15.2 | 17.0 | 16.4 | 16.4 |
| Elongation, % | 410 | 420 | 450 | 420 | 420 |
| Dispersion Index, % | 94.6 | 97.8 | 96.9 | 96.1 | 96.6 |
| Hardness, ShoreA | 61.7 | 62.3 | 62.9 | 62.9 | 61.9 |
| Die C Tear, KN/m | 1.84 | 1.84 | 1.87 | 1.88 | 1.88 |
| Zwick Rebound | | | | | |
| (Cured 48 Minutes | | | | | |
| @ 145° C.)- | | | | | |
| ISO4662/DIN53512 | | | | | |
| Zwick Rebound, % | 40.4 | 41.4 | 40.2 | 40.4 | 40.7 |
| Mooney Viscosity | | | | | |
| Properties | | | | | |
| @ 100° C. | | | | | |
| Large Rotor | | | | | |
| (ASTM D 1646) | | | | | |
| ML1 + 4 | 47.3 | 48.1 | 47 | 47.8 | 45.2 |
| Mooney Scorch | | | | | |
| Properties | | | | | |
| @ 135° C. | | | | | |
| Small Rotor | | | | | |
| (ASTM D 1646) | | | | | |
| T + 2, Min. Sec | 26.5 | 25.8 | 22.6 | 22.9 | 23.9 |
| T + 5, Min. Sec | 29.1 | 28.9 | 28.1 | 28.4 | 28.8 |
| T + 18, Min. Sec | 31.5 | 31.6 | 31.4 | 31.5 | 31.7 |
| T + 25, Min. Sec | 32.1 | 32.2 | 32.1 | 32.2 | 32.3 |
| T + 35, Min. Sec | 32.8 | 33.1 | 32.9 | 33.0 | 33.1 |

*Marshall Composite

TABLE 8
N550 - EPDM Extrusion Formulation

| | A | B | C | D | E |
|---|---|---|---|---|---|
| Rheometer Cure | | | | | |
| Properties | | | | | |
| ½° | | | | | |
| Arc 165° C. | | | | | |
| (ASTM D 5289) | | | | | |
| Max. Torque, dNm | 21.0 | 19.9 | 21.1 | 21.0 | 20.9 |
| Min. Torque, dNm | 2.2 | 1.8 | 2.2 | 2.2 | 2.2 |
| Net Torque, dNm | 18.9 | 18.0 | 18.9 | 18.8 | 18.7 |
| 1.0 Nm Rise, min. | 1.4 | 1.5 | 1.4 | 1.4 | 1.4 |
| 90% Net, min. | 11.5 | 11.5 | 11.2 | 11.0 | 11.3 |
| Stress Strain | | | | | |
| Properties | | | | | |
| (Cured 32 Minutes | | | | | |
| @ 145° C.)- | | | | | |
| ASTM D412/D3182 | | | | | |
| 100% Mod., MPa | 5.2 | 4.7 | 5.1 | 5.3 | 5.2 |
| 200% Mod., MPa | 9.8 | 8.6 | 9.6 | 10.0 | 9.8 |
| 300% Mod., MPa | | 11.4 | | | |
| Tensile, MPa | 12.6 | 12.1 | 12.5 | 12.7 | 12.4 |
| Elongation, % | 280 | 330 | 290 | 270 | 280 |
| Dispersion Index, % | 9.38 | 95.9 | 94.0 | 90.9 | 93.1 |
| Hardness, ShoreA | 67.4 | 66.4 | 69.0 | 68.4 | 67.0 |
| Zwick Rebound | | | | | |
| (Cured 48 Minutes | | | | | |
| @ 145° C.)- | | | | | |
| ISO4662/DIN53512 | | | | | |
| Zwick Rebound, % | 39.2 | 40.6 | 39.6 | 38.8 | 38.8 |
| Mooney Viscosity | | | | | |
| Properties | | | | | |
| @ 100° C. | | | | | |
| Large Rotor | | | | | |
| (ASTM D 1646) | | | | | |
| ML1 + 4 | 60.0 | 54.8 | 58.7 | 59.0 | 59.6 |
| Mooney Scorch | | | | | |
| Properties | | | | | |
| @ 135° C. | | | | | |
| Small Rotor | | | | | |
| (ASTM D 1646) | | | | | |
| T + 2, Min. Sec | 5.2 | 9.4 | 10.5 | 11.0 | 11.2 |
| T + 5, Min. Sec | 10.6 | 14.9 | 15.4 | 15.4 | 15.61 |
| T + 18, Min. Sec | 21.6 | 23.1 | 21.7 | 21.5 | 22.0 |
| T + 25, Min. Sec | 23.6 | 25.2 | 23.4 | 23.2 | 23.7 |
| T + 35, Min. Sec | 25.7 | 27.9 | 25.3 | 25.2 | 25.6 |

*Marshall Composite

While certain representative embodiments and details have been shown for the purpose of illustrating the invention, it will be apparent to those skilled in this art that various changes and modifications may be made therein without departing from the spirit or scope of the invention.

What is claimed is:

1. A carbon black comprising the features:
a) an average nitrogen surface area of a first conventional N500 series carbon black;
b) at least one performance property, in a polymeric composition, equal to or better than an identical performance property of a conventional N300 series carbon black in the same polymeric composition; and
c) an oxygen chemisorption value higher than a second conventional N500 series carbon black,
wherein the first conventional N500 series carbon black, the conventional N300
series carbon black and the second conventional N500 series carbon black are defined by ASTM-D1765.

2. The carbon black of claim 1 wherein the oxygen chemisorption value is at least 3.5 m² absorbed oxygen/gram of carbon black, as determined thermo gravimetrically.

3. The carbon black of claim 1, wherein the oxygen chemisorption value is at least 4.0 m² absorbed oxygen/gram of carbon black, as determined thermo gravimetrically.

4. The carbon black of claim 1, wherein the first conventional N500 series carbon black is an N550 grade carbon black as defined by ASTM-D1765.

5. The carbon black of claim 1, wherein the second conventional N500 series carbon black is an N550 grade carbon black as defined by ASTM-D1765.

6. The carbon black of claim 4, wherein the second conventional N500 series carbon black is an N550 grade carbon black as defined by ASTM-D1765.

7. The carbon black of claim 1, wherein the first and the second conventional N500 series carbon black are the same.

8. The carbon black of claim 1, wherein the ratio of the oxygen chemisorption value to the average nitrogen surface area is at least approximately 0.07:1.

9. The carbon black of claim 1, wherein the ratio of the oxygen chemisorption value to the average nitrogen surface area is at least approximately 0.10:1

10. The carbon black of claim 1, wherein the polymeric composition comprises rubber.

11. The carbon black of claim 1, wherein the at least one performance property is a higher modulus value.

12. The carbon black of claim 1, wherein the at least one performance property is a higher hysteresis value.

13. A carbon black comprising the features:
a) an average nitrogen surface area of a first conventional N500 series carbon black;
b) an oxygen chemisorption value higher than a second conventional N500 series carbon black,
wherein the first conventional N500 series carbon black and the second conventional N500 series carbon black are defined by ASTM-D1765.

14. A carbon black comprising the features:
a) an average nitrogen surface area of a conventional N500 series carbon black;
b) at least one performance property, in a polymeric composition, equal to or better than an identical performance property of a conventional N300 series carbon black in the same polymeric composition;
wherein the conventional N500 series carbon black and the conventional N300 series carbon black are defined by ASTM-D1765.

15. A polymeric composition comprising a polymer and the carbon black of claim 1.

16. The polymeric composition of claim 15, wherein the composition comprises rubber.

17. A process for the manufacture of a carbon black, the process comprising the steps:
a) combusting an oxidant and a fuel in a combustor section of a modified tread carbon black reactor to provide at least one combustion gas;
b) injecting a carbonaceous feedstock into a choke section of the reactor;
c) reacting the carbonaceous feedstock with the at least one combustion gas in the reactor, wherein the reactor has a choke velocity at the carbonaceous feedstock injection less than 250 meters per second;
to provide a carbon black comprising an average nitrogen surface area of a first conventional N500 series carbon black.

18. The process of claim 17, wherein the choke velocity is less than or equal to 200 meters per second.

19. The process of claim 17, wherein the choke velocity is less than or equal to 180 meters per second.

20. The process of claim 17, wherein the choke velocity is less than or equal to 150 meters per second.

21. The process of claim 17, wherein the carbon black further comprises at least one performance property, in a polymeric composition, equal to or better than an identical performance property of a conventional N300 series carbon black in the same polymeric composition.

22. The process of claim 21, wherein the carbon black further comprises an oxygen chemisorption value higher than a second conventional N500 series carbon black, wherein the first conventional N500 series carbon black, the conventional N300 series carbon black and the second conventional N500 series carbon black are defined by ASTM-D1765.

23. A process for the manufacture of a carbon black, the process comprising the steps:
a) combusting an oxidant and a fuel in a combustor section of a modified tread carbon black reactor to provide at least one combustion gas;
b) injecting a carbonaceous feedstock into a choke section of the reactor; and
c) reacting the carbonaceous feedstock with the at least one combustion gas in the reactor, wherein the reactor has a choke velocity at the carbonaceous feedstock injection less than 250 meters per second.

24. The process of claim 23, wherein the choke velocity is less than or equal to 200 meters per second.

25. The process of claim 23, wherein the choke velocity is less than or equal to 150 meters per second.

26. The process of claim 23, wherein the choke velocity is less than or equal to 100 meters per second.

27. The product produced by the process of claim 17.

28. The product produced by the process of claim 23.

29. The product of claim 28, wherein the product is an N400 series grade carbon black as defined by ASTM-D1765.

30. The product of claim 28, wherein the product is an N500 series grade carbon black as defined by ASTM-D1765.

31. The product of claim 28, wherein the product is an N600 series grade carbon black as defined by ASTM-D11765.

32. The product of claim 28, wherein the product is an N700 series grade carbon black as defined by ASTM-D1765.

33. A modified tread carbon black reactor for producing carbon black, wherein the reactor comprises, in open communication and in the following order, from upstream to downstream:
a) a combustion section, wherein the combustion section comprises at least one inlet for introducing a combustion feedstock;
b) a choke section, wherein the choke section comprises at least one inlet, separate from the combustion section inlet, for introducing a carbonaceous feedstock and wherein the choke section converges toward a downstream end, said downstream end having a minimum cross sectional area;
c) a quench section, having a minimum cross sectional area, wherein the quench section comprises at least one inlet, separate from the combustion section and choke section inlets, for introducing a quench material; and
d) a breaching section;
wherein the ratio of the quench section minimum cross sectional area to the choke section minimum cross sectional area of the modified tread reactor is less than the ratio of a quench section minimum cross sectional area to a choke section minimum cross sectional area of a conventional tread reactor.

34. The modified tread carbon black reactor of claim 33, wherein the ratio of the minimum cross sectional area of c) to the minimum cross sectional area of b) is in the range of from greater than 1.0 to less than 1.5.

35. The modified tread carbon black reactor of claim 33, wherein the ratio of the minimum cross sectional area of c) to the minimum cross sectional area of b) is in the range of from greater than 1.0 to 1.4.

36. The modified tread carbon black reactor of claim 33, wherein the ratio of the minimum cross sectional area of c) to the minimum cross sectional area of b) is in the range of from greater than 1.0 to 1.3.

37. The modified tread carbon black reactor of claim 33, wherein the ratio of the minimum cross sectional area of c) to the minimum cross sectional area of b) is in the range of from greater than 1.0 to 1.2.

38. The modified tread carbon black reactor of claim 33, wherein the ratio of the minimum cross sectional area of c) to the minimum cross sectional area of b) is in the range of from greater than 1.0 to 1.1.
